(19) United States
(12) Patent Application Publication
(10) Pub. No.: US 2008/0310052 A1
(43) Pub. Date: Dec. 18, 2008

(54) Apparatus and method for a ferroelectric disk and ferroelectric disk drive

(75) Inventor: Brian D. Strom, Cupertino, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 11/899,791

(22) Filed: Sep. 7, 2007

Related U.S. Application Data
(60) Provisional application No. 60/934,853, filed on Jun. 15, 2007.

(51) Int. Cl. G11B 5/82

(52) U.S. Cl. 360/135

(57) ABSTRACT

A ferroelectric disk is disclosed including disk surfaces and an electrode coupling formed on at least one of the disk surfaces and electrically coupled to an electrode sheet covered by a probe surface. A slider is disclosed including a resistive probe and an electrical coupling. A head gimbal assembly, head stack assembly and ferroelectric disk drive are disclosed including the slider. The ferroelectric disk drive is disclosed including at least one of the ferroelectric disks. Access operations for a track on the disk surface of a ferroelectric disk are disclosed.

### CROSS REFERENCE TO RELATED APPLICATIONS

This application claims priority to U.S. Provisional Patent Application No. 60/934,853, filed Jun. 15, 2007.

### TECHNICAL FIELD

This invention relates to the utilization of ferroelectric materials in a disk drive, in particular to a ferroelectric disk, a ferroelectric disk drive accessing the ferroelectric disk, and a slider electrically coupled to the ferroelectric disk.

### BACKGROUND OF THE INVENTION

The invention involves a new material used for a disk in a new disk drive, based upon the ferroelectric effect. Before summarizing the invention, this section will review two primary memory storage architectures and then review the most current research pointing to the invention. A third primary memory architecture involving tape drives is not discussed because it is not seen as relevant to this invention.

A hard disk drive implements the first memory architecture, which stems from the inventions of Thomas Edison, and involves a rotating surface, over which an actuator positions a sensor, which may also include a writing device. Starting with the gramophone in the late nineteenth century, it has evolved into the modern optical disk drive, removable media disk drives, as well as the hard disk drive, which collectively hold the record for the greatest density of information at the lowest cost per bit, and have throughout most of their history. This architecture tends to support access of data in long strings, often arranged as closed tracks on the rotating surface. Conventional hard disk drives currently operate at a storage density of 133 gigabits per square inch using ferromagnetic memory cells.

The second memory architecture stems from the invention of arrays of memory cells arranged to be accessed in a much smaller unit, often called a byte or word. It was implemented with ferromagnetic core memories by mid twentieth century, and evolved into today's flash memory, dynamic and static RAM devices. These tend to serve computers as random access devices or serve as media storage devices emulating disk drives. They have been at the forefront in providing rapid access of data in essentially random addressing patterns.

By way of comparison memory cell arrays emulating disk drives have tended to have smaller overhead, in that typically a column is accessed at a time. The columns tend to be a fixed length string of bits used like a sector on a disk drive.

Finally, there is considerable interest in using ferroelectric materials for memory applications, known as ferroelectric memory devices. These devices are known for being non-volatile with very high write-erase cycling before failure. Ferroelectric memory cells on the order of nanometers are believed feasible. Today, the typical application of this memory technology is in a Ferroelectric Random Access Memories, or FRAMs, a memory cell array. Typically, the FRAM is an array of ferroelectric capacitors arranged in cells similar to Dynamic RAM (DRAM) cells, except that the dielectric layer of the DRAM cell is replaced with a ferroelectric film, often composed of ferroelectric material such as lead zirconate titanate. While in general similar to the capacitors used in DRAM cells, the ferroelectric film retains an electric field after the charge in the capacitor drains, making it non-volatile. These cells can be written in under 100 nanoseconds (ns), making them as fast to write as to read and much faster to write than other contemporary non-volatile semiconductor memory cells. Their manufacturing process typically involves two additional masking steps when compared to normal semiconductor manufacturing processes.

An article entitled “Scanning resistive probe microscopy: Imaging ferroelectric domains” by Park, et. al. in the Applied Physics Letters Volume 84, number 10, pages 1734-1736 reports verifying a resistive probe that could detect a ferroelectric domain at high speed and be used as a read-write head in a resistive probe data storage system, which is incorporated herein by reference. While this research is fundamental and necessary, there remain significant problems to be solved.

The reported current sensitivity of the resistive probe “[I_{R}(V_{G}=1 V)-I_{R}(V_{G}=0 V)]/I_{R}(V_{G}=0 V)” was measured to be 0.3% to 0.5%. The resistive probe signal will need to travel on the order of 4 centimeters (cm), making it necessary to deal with transmission noise at its destination. Methods and apparatus are needed that strengthen resistive probe sensitivity before transmission.

The article reports asserting 30 volts between the resistive probe site and the electrode on the other side of the ferroelectric film to alter the electric field in a first direction and asserting −30 volts to alter the electric field in a second, opposite direction. This poses a second problem, suppose that the bits to be written on a ferroelectric disk were 5 nanometers (nm) apart, that the ferroelectric disk was 75 millimeters wide and rotates at 6000 revolutions per minute. Assume that a track has a diameter of 75 mm and is written with data for every bit it can hold in one revolution. This works out to roughly 47 Million bits written in 1 part of 6000 of a minute, or one hundredth of a second. Put another way, an alternating current signal at a frequency of over one Gigahertz with amplitude of 30 Volts needs to be provided, again transmitted over the 4 centimeters. This may pose serious problems with inductive coupling and noise. Methods and apparatus are needed to minimize the inductive effects associated with writing data to a track on a ferroelectric disk.

Also in the article, there is a discussion of how the resistive probe was used to polarize the ferroelectric domain. A voltage was applied between the resistive tip of the resistive probe and an electrode of the ferroelectric film to polarize the ferroelectric domain. Applying the voltage to an electrode of a ferroelectric domain measuring 37 cm in radius may bring with it problems. The ferroelectric film is essentially a capacitor, as mentioned earlier. Methods and apparatus are needed for sharing the electrode and/or supporting ferroelectric domains of limited surface area.

U.S. Pat. No. 6,515,957 “Ferroelectric drive for data storage,” discloses a ferroelectric disk drive using two transducers, one for reading and one for writing operations. The write transducer is a sharp, electrically conductive tip, closely spaced adjacent to the magnetic medium for the write operation. The read transducer is a field effect transducer, which also must be spaced close to the media to resolve the written ferroelectric domains. It is unclear at this time whether the read transducer may not suffer similar limitations to the read head of conventional hard disk drives, which may well limit their usefulness with ferroelectric cells at or below 50 nm pitch.

Conventional hard disk drives operate at storage density 133 Gigabits per square inch. One future goal is to record at one thousand gigabits per square inch or 1 Terabit (Tb) per square inch. This density may be achieved, for example, if bits are recorded in a square matrix at a 50 nanometer pitch, which appears beyond the capabilities of the ferromagnetic cells used in these hard disk drives. A new disk drive is needed to reach this target storage density.

### SUMMARY OF THE INVENTION

One embodiment of the invention is a ferroelectric disk drive including at least one embodiment of a ferroelectric disk attached by at least one disk mounting component to a spindle motor. The ferroelectric disk includes at least one electrode sheet buried beneath a resistive probe surface with an electrode coupling through the disk mounting component to create an electrode path to a slider in the head stack assembly. The electrode path forms an electrical circuit between the electrode sheet and a resistive probe in the slider accessing the state of a ferroelectric cell retained by a ferroelectric film situated between the resistive probe surface and the electrode sheet. The disk mounting components may include a disk mount, a disk clamp, and/or possibly one or more disk spacers. The resistive probe surface may preferably include a layer of lubricant over a layer of Diamond Like Carbon (DLC) over the ferroelectric film. The resistive probe may preferably make contact with the lubricant without penetrating it, thereby avoiding solid-to-solid contact with the DLC layer.

A method of the invention accesses data on the disk surface of the ferroelectric disk, through reading and writing a track on the disk surface by providing voltages between resistive probe sites through the electrode path between the slider and the electrode sheet, for the ferroelectric cell of each bit in the track. The invention includes the bit values of the bits in the track, as a product of the access process.

Another embodiment of the invention is a slider including an electrical coupling to the electrode path to the electrode sheet, a resistive probe contacting the resistive probe surface to provide a voltage to the probe site of the ferroelectric cell with respect to the electrode sheet and an amplifier sensing the current through the resistive probe to create an amplified read signal. The amplifier acts to increase the sensitivity of the resistive probe and reduce the transmission noise effects on the amplified read signal.

Three other embodiments of the invention are assemblies of the slider: a head gimbal assembly, a head stack assembly and a ferroelectric disk drive, each include an embodiment of the slider and provide the electrode path between at least one electrode sheet to the amplifier in the slider for accessing data stored in ferroelectric cells on at least one disk surface of a ferroelectric disk.

### BRIEF DESCRIPTION OF THE DRAWINGS

FIG. 1 shows a cutaway view of an example embodiment of the ferroelectric disk drive, including a ferroelectric disk rotated by a spindle motor to create a rotating disk surface. The rotating disk surface is accessed by an embodiment of the slider positioned near a track by an embodiment of the head stack assembly in the voice coil motor;

FIG. 2A shows some details of the voice coil motor and an example embodiment of the head stack assembly including at least one embodiment of the head gimbal assembly;

FIG. 2B shows a side view of some further details of an example of the head gimbal assembly of FIGS. 1 and 2A where the slider includes a resistive probe in contact with the disk surface and flying on an air bearing caused by wind from the rotation of the disk surface;

FIG. 3 shows in a schematic fashion an electrode sheet in the ferroelectic disk coupling through at least one of the disk mounting components to create the electrode path through the ferroelectric disk drive and the head stack assembly to the slider. The disk mounting components consist of a disk mount, possibly one or more disk spacers and a disk clamp;

FIG. 4A shows a simplified view of an example resistive probe in the slider using the electrode path to create a circuit between the electrode sheet, the ferroelectric film and the resistive probe surface in the disk surface, where the resistive probe contacts the resistive probe surface at a resistive probe site and a ferroelectric cell is formed between the resistive probe site on the resistive probe surface, the ferroelectric film between the resistive probe surface and the electrode sheet using the electrode path shown in FIG. 3;

FIG. 4B shows a simplified schematic layer diagram of further details of the ferroelectric cell of FIG. 4A with the resistive probe surface including a layer of Diamond Like Carbon (DLC) topped by a layer of lubricant;

FIG. 4C shows the operation of the ferroelectric cell of FIGS. 4A and 4B with regards to a first electric field direction;

FIG. 4D shows the operation of the ferroelectric cell of FIGS. 4A and 4B with regards to a second electric field direction, essentially opposite that of the first electric field direction of FIG. 4C;

FIG. 5A shows an example ferroelectric disk drive with an example ferroelectric disk providing the electrode coupling on the same disk surface as the ferroelectric film, and using the disk clamp through a rolling electrode coupling to create the electrode path to the slider;

FIG. 5B shows an example ferroelectric disk drive with another example ferroelectric disk providing the electrode coupling on the opposite disk surface as the ferroelectric film, and using a disk spacer to create the electrode path to the slider;

FIG. 5C shows an example ferroelectric disk drive with the ferroelectric disk providing two of the electrode couplings, each on the same disk surface as the ferroelectric films, which use both disk surfaces of the ferroelectric disk. The electrode couplings are provided to separate sliders;

FIG. 5D shows an example ferroelectric disk drive with the ferroelectric disk providing one electrode coupling to the ferroelectric films of both disk surfaces of the ferroelectric disk;

FIG. 6 shows a bottom view of an example embodiment of the micro-actuator assembly of FIG. 2B for positioning the slider of the previous Figures, including a third piezoelectric device to at least partly control the contact pressure of the resistive probe to the disk surface;

FIG. 7A shows a side view of an example embodiment of an electrostatic micro-actuator assembly for positioning the slider which may also at least partly control the contact pressure of the resistive probe to the disk surface;

FIG. 7B shows the view from the slider of the micro-actuator assembly of FIG. 7A showing two electrostatic micro-actuators, a central moveable section, a bonding block to the slider, and some details of the first electrostatic micro-actuator;

FIG. 8A shows a simplified schematic of the slider using the electrode path and the resistive probe to create a sensed current presented to an amplifier in the amplifier; and

FIG. 8B shows a refinement of the schematic of FIG. 8A, where the electrode path is used as a ground for the slider, the amplifier further includes a write amplifier, and the slider further includes a vertical micro-actuator at least partly controlling the contact pressure of the resistive probe on the rotating disk surface.

### DETAILED DESCRIPTION

This invention relates the utilization of ferroelectric materials in a disk drive, in particular to a ferroelectric disk, a ferroelectric disk drive accessing the ferroelectric disk, and a slider receiving an electrode path electrically coupled the electrode sheet of the ferroelectric disk and using an amplifier to sense a current between a resistive probe and the electrode path.

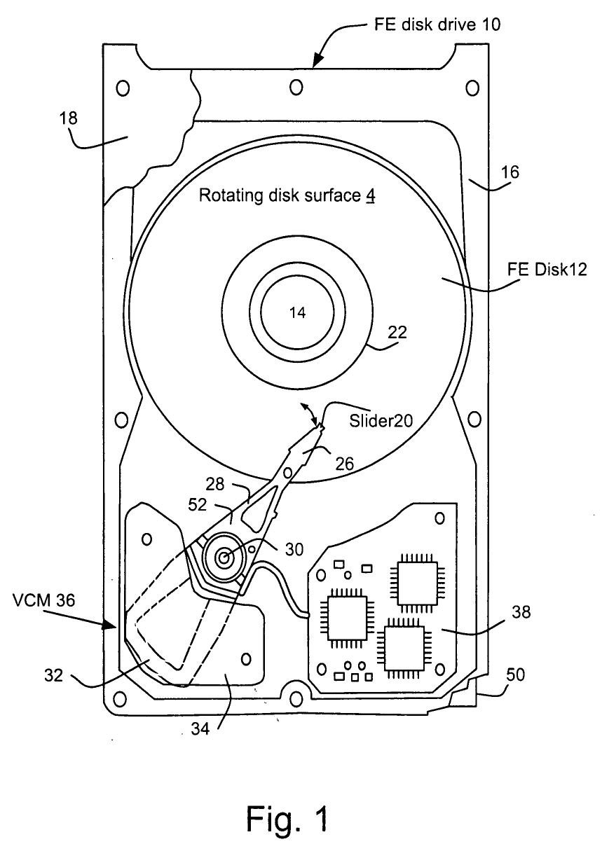

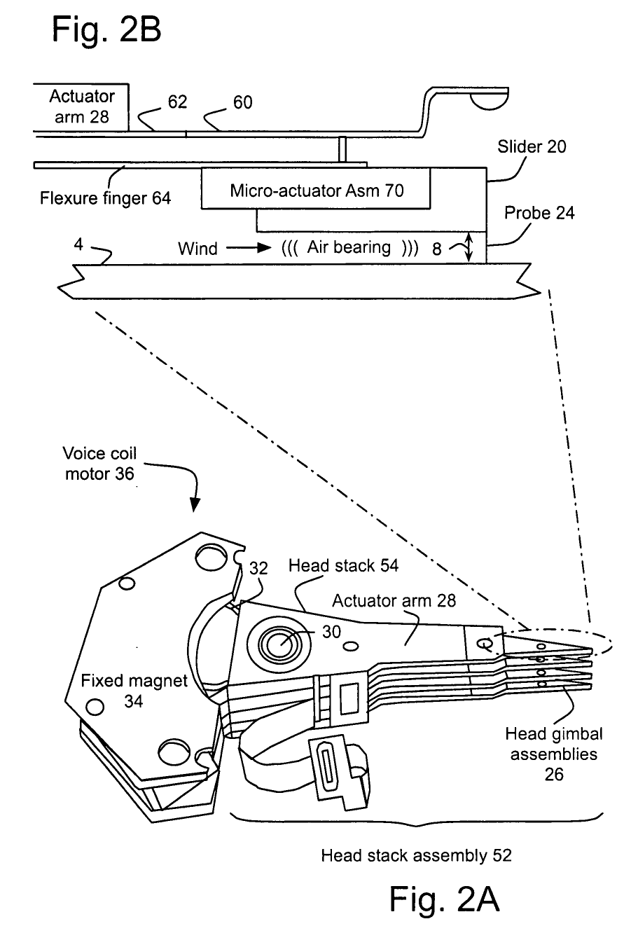

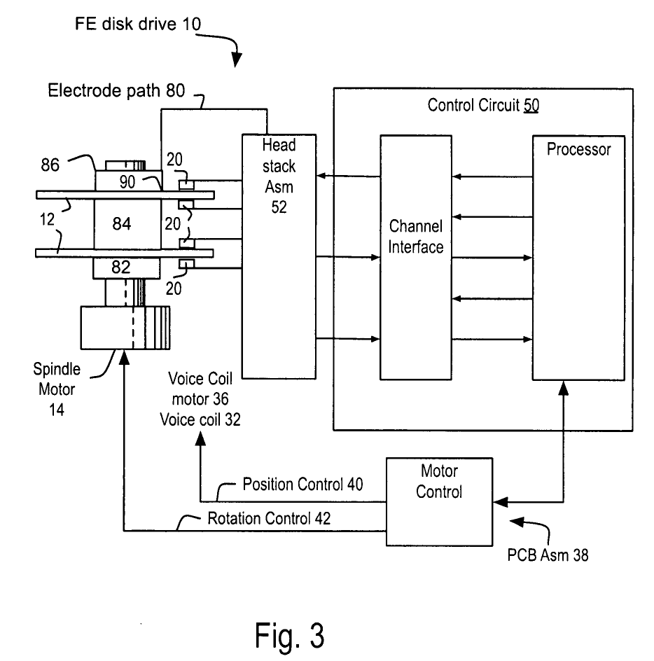

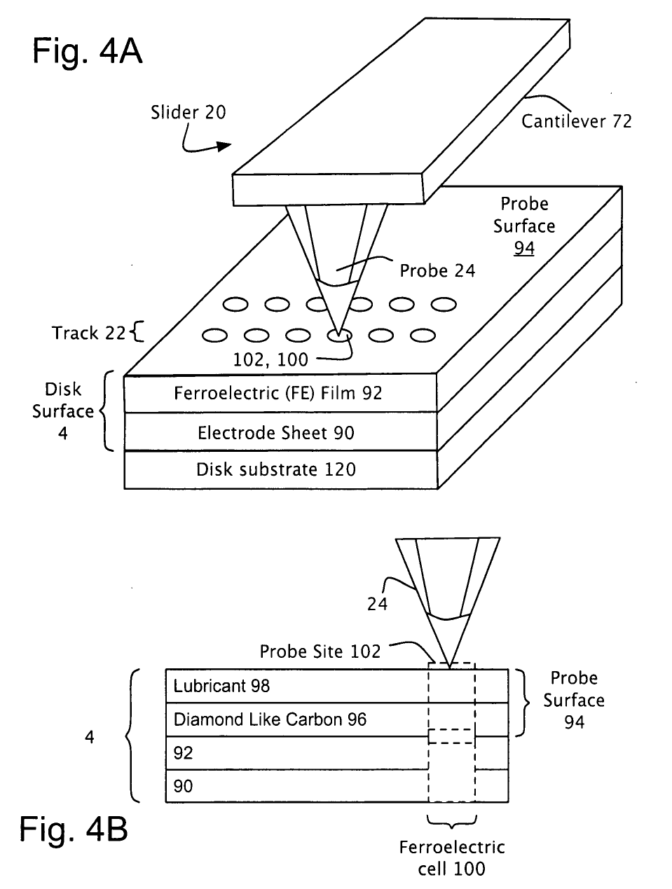

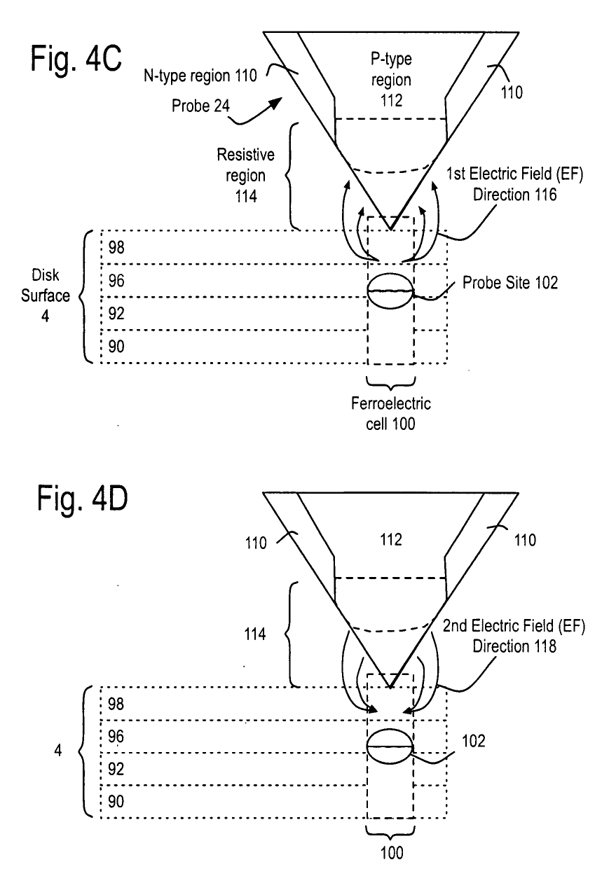

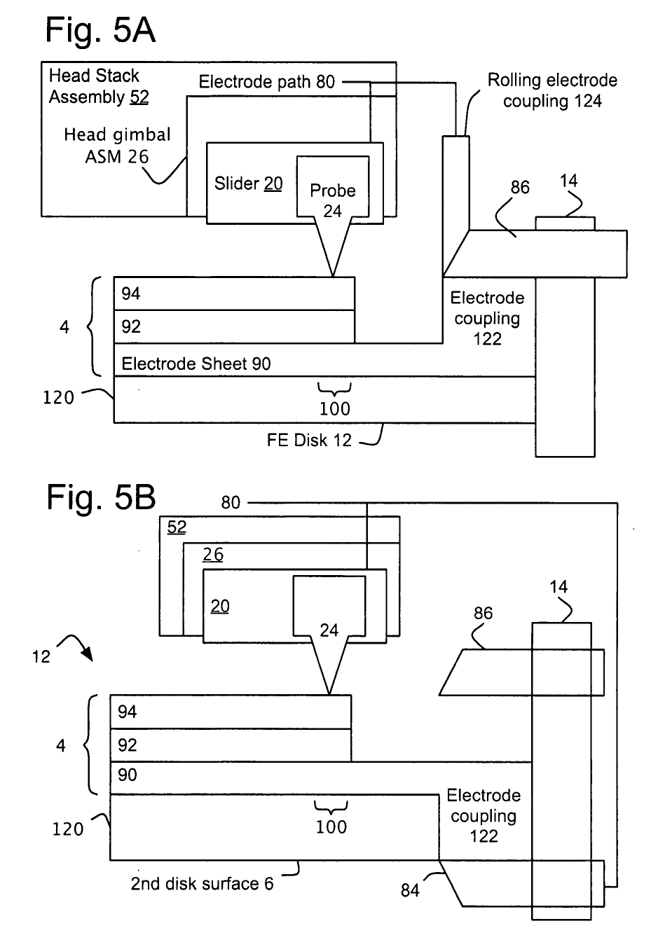

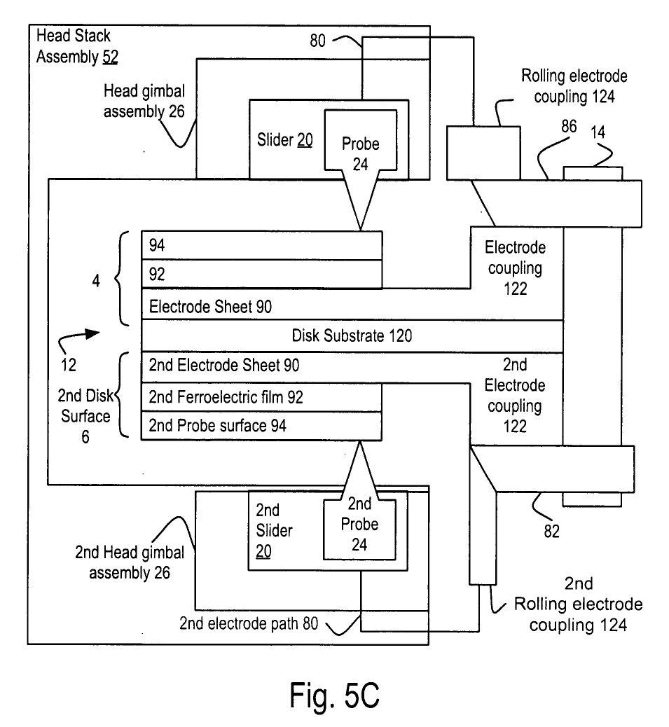

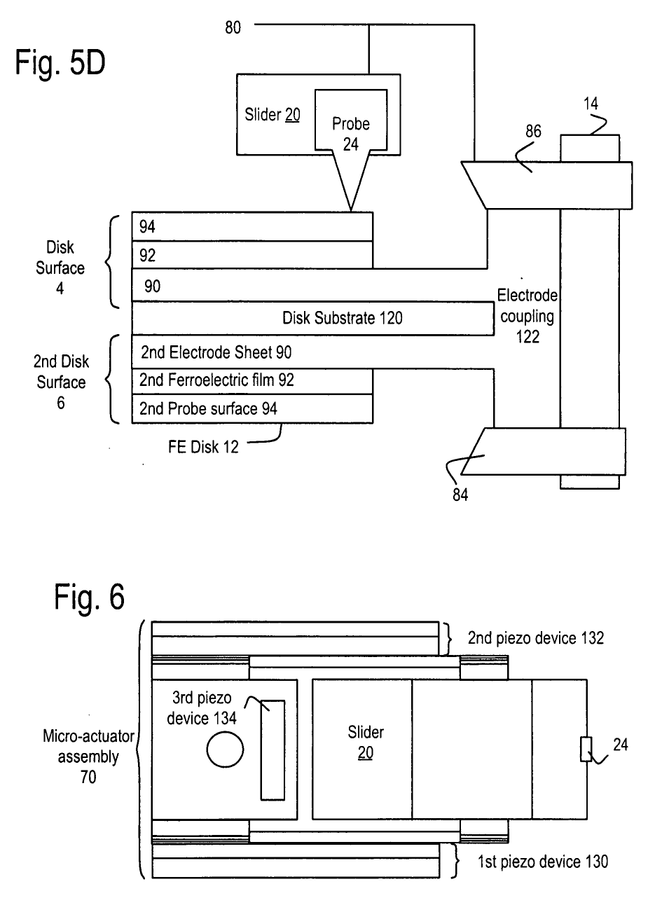

Several embodiments of this invention act at different levels to create the claimed embodiments of a ferroelectric disk drive 10. Before entering a more detailed discussion, here is an outline of the components and their interactions: The ferroelectric disk drive includes at least one embodiment of a ferroelectric disk 12 as shown in FIGS. 1, 3, and in further detail in FIGS. 5A to 5D. The ferroelectric disk includes at least one electrode sheet 90 buried beneath a resistive probe surface with an electrode coupling 122 to create an electrode path 80 to a slider 20, as shown in FIGS. 2A to 3, and in further detail in FIGS. 5A to 5D. The electrode path forms an electrical circuit between the electrode sheet and the slider. A resistive probe 24 in the slider accesses the state of a ferroelectric cell, as shown in FIGS. 4A to 4D. Various details of the slider are shown in FIGS. 2A, 4A to 4D, 7A, 8A and 8B.

FIG. 1 shows a cutaway view of an example embodiment of the ferroelectric disk drive 10, including an embodiment of the ferroelectric disk 12 rotated by the spindle motor 14 to create the rotating disk surface 4. The rotating disk surface is accessed by an embodiment of the slider 20 positioned near a track 22 by an embodiment of the head stack assembly 52 in a voice coil motor 36.

The voice coil motor 36 includes a voice coil 32 coupled to the head stack assembly 52, which is mounted by the actuator pivot 30 to the disk base 16 so that the head stack assembly rotates through the actuator pivot in response to the interaction between the voice coil and the fixed magnet assembly 34. The head stack assembly includes at least one actuator arm 28 coupled to at least one embodiment of a head gimbal assembly 26. The head gimbal assembly includes an embodiment of the slider 20, which is positioned near a track 22 on the rotating disk surface 4.

In many embodiments of the ferroelectric disk drive 10, a control circuit 50 stimulates the spindle motor to rotate the ferroelectric disk, creating the rotating disk surface 4. The control circuit may further stimulate the voice coil 32 to cause the voice coil motor 36 to position the slider 20 near the track 22. Some embodiments of the ferroelectric disk drive 10 may include a printed circuit board assembly 38, which may be driven by the control circuit to stimulate the voice coil and/or the spindle motor.

FIG. 2A shows some details of the voice coil motor 36 and an example embodiment of the head stack assembly 52 including at least one embodiment of the head gimbal assembly 26 coupling through an actuator arm 28 of the head stack 54.

In some embodiments of the ferroelectric disk drive 10, the head stack assembly 52 may include one actuator arm 28 as shown in FIG. 1, or it may include more than one actuator arm as shown in FIG. 2A. An actuator arm may couple to one head gimbal assembly. In some embodiments of the head stack assembly, at least one of the actuator arms may couple to two of the head gimbal assemblies.

FIG. 2B shows a side view of some further details of the head gimbal assembly 26 of FIGS. 1 and 2A where the slider 20 includes a resistive probe 94 in contact with the disk surface 4 at a contact pressure 8 and flying on an air bearing caused by wind from the rotation of the disk surface. The head gimbal assembly may include a flexure finger 64 coupling to a micro-actuator assembly 70 and the slider 20. The flexure finger may also couple to a load beam 60, which connects through a base plate 62 to the actuator arm 28. The load beam may use a hinge to mechanically connect to the base plate, which has not been shown. The base plate may be swaged to the actuator arm to couple them together.

Both embodiments of the ferroelectric disk drive 10, the head gimbal assembly 26 and the head stack assembly 52, provide the electrode path 80 between the electrode sheet 90 and the slider 20, which is also included in these embodiments.

FIG. 3 shows in a schematic fashion an electrode sheet 90 in the ferroelectric disk 12 coupling through at least one of the disk mounting components to create the electrode path 80 through the ferroelectric disk drive 10 and the head stack assembly 52 to the slider 20. The disk mounting components consist of a disk mount 82, possibly one or more disk spacers 84 and/or a disk clamp 86.

Operating the ferroelectric disk drive 10 may include the following. The spindle motor 14 is directed by the control circuit 50 through a rotation control signal 42 to rotate the ferroelectric disk 12, preferably bringing it up to a nearly constant rotational velocity. The electrode coupling 90 of the disk surface 4 electrically couples through at least one of the disk mounting components to create the electrode path 80 provided to the slider 20. Accessing the data of the track 22 includes stimulating the voice coil 32 with a position control signal 40 delivered as a time varying electric signal to the voice coil, which interacts with the fixed magnet 34 to alter the lateral position of the slider until it is near the track. The control circuit may directly present the position control signal or stimulate a motor control interface to drive the voice coil motor. Once the slider is close to the track, the ferroelectric disk drive enters a track following mode. A micro-actuator assembly 70 may be employed during track following and possibly also during the track seek operation. During track following mode, the read-write signal bundle may stimulate a preamplifier included in the head stack assembly 52 to at least partly create the read-write signals received by the control circuit, in particular by a processor communicating through a channel interface to access the data in the track on the rotating disk surface.

Data stored on the disk surface 4 of the ferroelectric disk 12 may preferably be accessed through reading and writing the track 22 on the disk surface by providing voltages between resistive probe sites and the electrode sheet 90, for the ferroelectric cell of each bit in the track as shown in FIGS. 4A to 4D. The electrode path 80 shown in FIG. 3 electrically couples the electrode sheet 90 to the slider so that this voltage may be provided. The invention includes the bit values of the bits in the track, as a product of the access process.

FIG. 4A shows a simplified view of an example resistive probe 24 in the slider 20 using the electrode path 80 of FIG. 3 to create the circuit between the electrode sheet 90 and the resistive probe 24 on the disk surface 4, where the resistive probe contacts the surface at a resistive probe site 102 to access a ferroelectric cell 100. The ferroelectric cell may be formed between the resistive probe site on the resistive probe surface, the ferroelectric film between the resistive probe surface and the electrode sheet through the electrode path 80.

The electrode sheet 90 may be deposited on a disk substrate 120. The disk substrate may include a glass disk substrate and or a metallic disk substrate similar to those used in contemporary ferromagnetic disks for hard disk drives. The electrode sheet may include at least one conductive metal. For the purpose of clarity, the application will speak of the electrode sheet and the disk substrate as distinct, however there may be embodiments where they are essentially the same.

The ferroelectric film 92 may include a concentration, essentially consisting of the group of elements in a mixture: lead (Pb), zirconium (Z), titanium (Ti), and oxygen (O). These elements may further form a compound, and the ferroelectric film may preferably include the Pb(Zr_{0.4}Ti_{0.6})O₃ compound. The concentration may preferably be at least ninety percent of the molecular weight of the ferroelectric film.

FIG. 4B shows a schematic layer diagram of further details of the ferroelectric cell 100 of FIG. 4A with the resistive probe surface 94 including a layer of Diamond Like Carbon (DLC) 96 topped by a layer of lubricant 98. The resistive probe 24 preferably contacts the lubricant layer without penetrating it, thereby avoiding solid-to-solid contact with the DLC layer. The diamond like carbon layer may be manufactured by high energy deposition of carbon on the ferroelectric film. The lubricant layer may include at least one lubricant compound from the perfluoropolyether family.

FIG. 4C shows the operation of the ferroelectric cell 100 of FIGS. 4A and 4B with regards to a first electric field direction 116. The resistive probe 24 may include an N-type region 110 which preferably surrounds a P-type region 112, both of which couple to a resistive region 114 contacting the resistive probe surface 94, preferably, the lubricant layer 98.

FIG. 4D shows the operation of the ferroelectric cell 100 of FIGS. 4A and 4B with regards to a second electric field direction 118, essentially opposite that of the first electric field direction 116 of FIG. 4C.

The disk surface 4 of the ferroelectric disk 12 may include at least two instances of the ferroelectric cell 100 in the track 22, as shown in FIG. 4A. Each ferroelectric cell sustains its electric field direction in a non-volatile manner. As used herein a memory is volatile if it tends to lose its memory contents when not supplied power on a regular basis, and non-volatile when it retains its memory contents without being supplied power regularly. By way of example, static rams and dynamic rams are volatile memories and ferroelectric and flash memories are non-volatile.

At least two ferroelectric cells 100 may share an electrode sheet 90. In certain embodiments, the ferroelectric cells of a sector may share a single electrode sheet, which may or may not be shared with other sectors in a track 22. The electrode sheet may be shared by all the sectors of a track but not with all tracks of a disk surface 4. In other embodiments, all the ferroelectric cells of all the bits accessed through the tracks of one disk surface may share a single electrode sheet as shown in FIGS. 5A to 5D.

Some of the embodiments of the ferroelectric disks 12 include at least one electrode sheet 90 buried beneath a resistive probe surface with one or more electrode couplings 122 through the disk mounting component 82, 84 and/or 86 to create an electrode path 80 through the ferroelectric disk drive 10 to a slider 20 in the head stack assembly 52.

FIG. 5A shows an example ferroelectric disk drive 10 with an example embodiment ferroelectric disk 12 providing the electrode coupling 122 on the same disk surface 4 as the ferroelectric film 92, and using the disk clamp 86 through a rolling electrode coupling 124 to create the electrode path 80 to the slider 20. The head stack assembly 52 and the head gimbal assembly 26 are shown providing the electrode path to the slider 20.

FIG. 5B shows an example ferroelectric disk drive 10 with another example ferroelectric disk 12 providing the electrode coupling 122 on the opposite disk surface 6 as the ferroelectric film 92, and using a disk spacer 84 to create the electrode path 80 to the slider 20.

FIG. 5C shows an example ferroelectric disk drive 10 with another example ferroelectric disk 12 providing two electrode couplings 122, each on the same disk surface as the ferroelectric films 92, which use both disk surfaces of the ferroelectric disk. The electrode couplings are provided through separate electrode paths 80 to separate sliders 20 through the head stack assembly 52 providing the separate electrode paths to different head gimbal assemblies 26, which in turn provide their electrode path to their slider, each using their resistive probe 24 to contact a different probe surface 94 to access data in separate ferroelectric films 92.

FIG. 5D shows an example ferroelectric disk drive 10 with another example ferroelectric disk 12 providing one electrode coupling 122 to the multiple ferroelectric films 92 of both disk surfaces 4 and 6 of the ferroelectric disk. The single electrode path 80 is then used by the sliders 20 to form the electrical circuit between the electrode sheet 90, the probe surface 94 contact by their resistive probe and the ferroelectric film 92 between their probe surface and their electrode sheet to access the data retained in its ferroelectric cells 100 as discussed above.

The ferroelectric disk 12 including the first disk surface 4 preferably provides multiple tracks of ferroelectric cells, each track 22 organized as multiple sectors, with each sector including at least one ferroelectric cell 100, preferably arranged as a payload of N ferroelectric cells and an envelope of M ferroelectric cells, where N is typically a power of two, often at least 2̂8=256, and M is sufficient for the envelope to function as the coding overhead for an error correcting/detecting coding scheme. Each ferroelectric cell includes a probe site 102 on the ferroelectric film 92.

A ferroelectric domain preferably includes at least two ferroelectric cells 100 sharing an electrode sheet 90. Each ferroelectric cell may sustain its electric field direction in a non-volatile manner. There may be more than one ferroelectric domain on a disk surface. To simplify the discussion, only a single ferroelectric domain will be shown and discussed hereafter. This is being done to simplify the discussion and not to limit the scope of the invention.

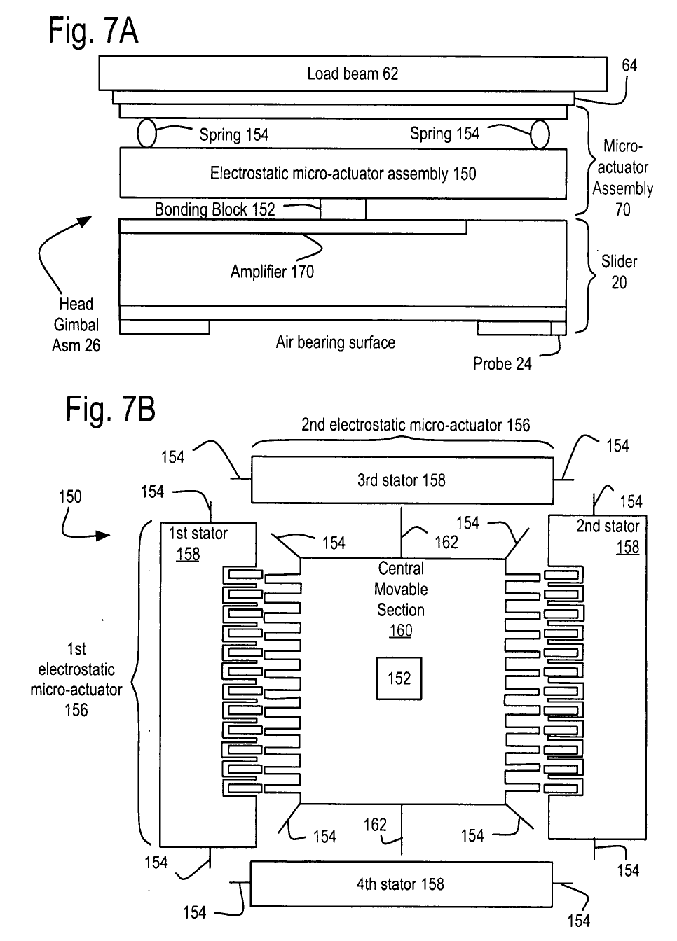

Another embodiment of the invention is a head gimbal assembly 26 including one of these sliders 20, providing the electrode path 80 to the slider as shown in FIGS. 5A to 5D. The head gimbal assembly may further include a micro-actuator assembly 70 coupled to the slider to at least partly control the contact pressure 8 of the resistive probe 24 on the disk surface 4, as shown in FIG. 2B. As in traditional micro-actuator assemblies used in ferromagnetic hard disk drives, the micro-actuator assembly preferably also alters the lateral position of the slider on the disk surface. Two embodiments of these micro-actuator assemblies will now be discussed, the first using a piezoelectric effect to alter the contact pressure in FIG. 6 and the second embodiment using an electrostatic effect in FIGS. 7A and 7B.

FIG. 6 shows a bottom view of an example embodiment of the micro-actuator assembly 70 for positioning the slider 20 of the previous Figures, including a third piezoelectric device 134 to at least partly control the contact pressure of the resistive probe 24 of the slider 20. The micro-actuator assembly may further include a first piezoelectric device 130 and possibly a second piezoelectric device 132 coupled to the slider to alter the lateral position of the resistive probe 24 near the track 22 on the rotating disk surface 4.

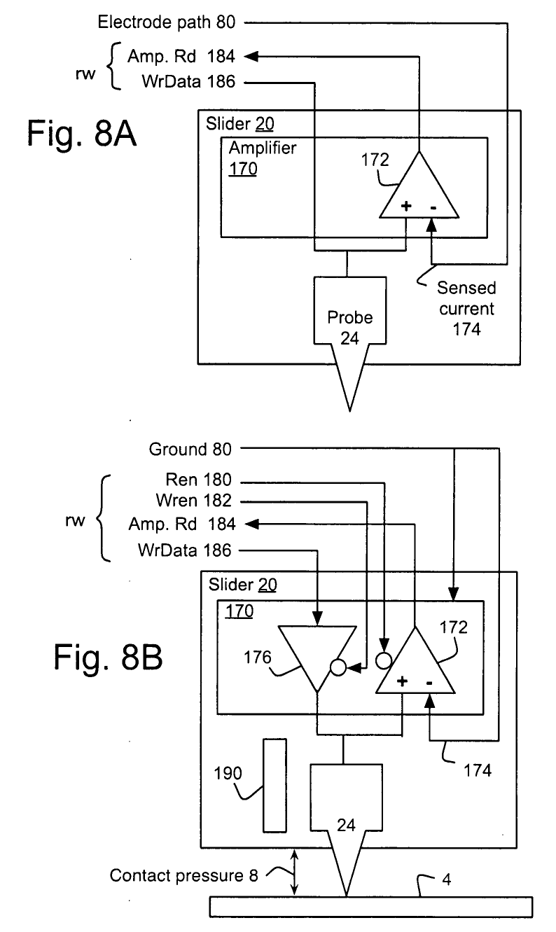

FIG. 7A shows a side view of an example embodiment of a micro-actuator assembly 70 including an electrostatic assembly 150 coupling to the head gimbal assembly 26 through at least two springs 154 and coupling through a bonding block 152 to the slider 20 to position and at least partly control the contact pressure of the resistive probe 24. The slider may further include an amplifier 170, which will be discussed in more detail with regards to FIGS. 8A and 8B.

FIG. 7B shows the view from the slider 20 of the micro-actuator assembly 70 of FIG. 7A of the electrostatic micro-actuator assembly 150 including a first and a second electrostatic micro-actuator 156, a central moveable section 160, a bonding block 152 to the slider 20, with some of the details of the first electrostatic micro-actuator. The first electrostatic micro-actuator includes a first stator 158 for electrostatic interaction with the central moveable section on the left and a second stator for electrostatic interaction on the right of the central moveable section. The second electrostatic micro-actuator includes the third stator 158 above and the fourth stator below the central moveable section. Some or all of the springs may provide signals communicating with the slider through the central moveable section, shown here as signal carrying springs 162.

The amplifier 170 of FIG. 7A preferably includes a read amplifier 172 generating the amplified read signal 946 that acts to increase the sensitivity of the resistive probe 184 and reduce the transmission noise effects. In some configurations, a write data signal 186 may directly drive the resistive probe.

FIG. 8A shows a simplified schematic of an example embodiment of the slider 20 using the electrode path 80 and the included resistive probe 24 to create a sensed current 174 presented to the amplifier 170, which further includes the read amplifier 172. The write data signal 186 may be provided to the resistive probe and used to bias the read amplifier to determine the sensed current from the electrode path.

The resistive probe 24 preferably operates as follows. The resistive region 114 is much higher in resistance than the highly doped regions 110, it acts as a small resistor at the tip of the resistive probe. When the tip approaches the ferroelectric material, electrons, as the majority carriers in the resistive region are depleted by the electric field from the negative surface charges. The depletion of the majority carriers alters the volume of the conducting path of the resistive region, resulting in a resistance change.

Alternatively, the majority carriers may be accumulated in the resistive region by the second electric field 118 from the positive surface charges as shown in FIG. 4D. The accumulation of majority carriers may alter the carrier density of the conducting path in the resistive region 114, also resulting in a second resistance change.

These changes in resistance in the resistive probe 24 may alter the sensed current 174 in the slider 20. This sensed current is then amplified offset by the electrical coupling of the electrode path 80 to generate the amplified read signal 184.

FIG. 8B shows a refinement of the schematic of FIG. 8A, where the electrode path 80 is used as a ground for the slider 20, the amplifier 170 further includes a write amplifier 176. Note that a specific signal convention, using an active low write enable signal 182 and an active low read enable 180 is shown, but that any of a number of alternative signal conventions could be used. The resistive probe 24 is directly coupled to the output of the write amplifier and one of the differential inputs of the read amplifier. The write data signal may be an electrical signal or an optical signal and may involve more than one signal path, for instance two paths for a differential signal pair of electrical signals.

Accessing data stored on a disk surface 4 will be discussed by an example using a track 22 on the disk surface 4 as shown in FIGS. 4A with some of the details of the slider shown in FIG. 8B. A first voltage may be provided between the probe site 102 on the probe surface 94 and the electrode path 80, causing a ferroelectric cell 100 approximating the vertical footprint of the probe site to sustain a first electric field direction 116, as shown in FIG. 4C. Providing a second voltage between the probe site and the ground coupling may cause the ferroelectric cell to sustain a second electric field direction 118 essentially opposite the first electric field direction, when the second voltage is opposite the first voltage in sign as shown in FIG. 4D. The electric field of the ferroelectric cell may be determined by measuring a sensed current 174 when a third voltage is applied between the probe site and the ground coupling.

In certain embodiments of the invention, the slider 20 may further include a vertical micro-actuator 190 at least partly controlling the contact pressure of the resistive probe 20 on the rotating disk surface 4. The vertical micro-actuator may employ a thermal mechanical effect, a piezoelectric effect and/or an electro-static effect.

The resistive probe 24 is preferably conical in shape and includes the resistive region 114 composed of the low doped n+ type material electrically coupled to the p-type region 112 and in certain embodiments, preferably connected to metal pads on a cantilever 72 through highly doped n-type regions 110 on the incline, which electrically couples the resistive probe to the amplifier 170.

In certain embodiments, a Position Error Signal may be provided to the control circuit 50 of FIG. 3 based upon the amplified read signal 184 generated by the amplifier 170 included in the slider 20, which may preferably be responsible for stimulating the voice coil motor 36 and the micro-actuator assembly 70 to position the resistive probe 24 near the track 22.

Manufacturing the ferroelectric disk drive 10 may include assembling a ferroelectric disk stack including the spindle motor 14, at least one of the disk mounting components 82, 84, and 86 with, at least one of the ferroelectric disks 12, assembling a head stack assembly 52, mounting the ferroelectric disk stack onto a disk base 14, rotatably coupling the head stack assembly through the actuator pivot 58 to the disk base and aligning it with the fixed magnets 34 to create the voice coil motor 30, coupling the control circuit 50 to the voice coil motor and the disk base, and to the ferroelectric disk stack to create a partly assembled ferroelectric disk drive. The disk cover 16 may be mounted over the partly assembled ferroelectric disk drive to create the ferroelectric disk drive 10.

The preceding embodiments provide examples of the invention and are not meant to constrain the scope of the following claims.

What is claimed is:

1. A ferroelectric disk drive, comprising:
a disk base;
at least one ferroelectric disk attached by at least one disk mounting component to a spindle motor mounted on said disk base, said ferroelectric disk including:
a disk surface comprising an electrode sheet covered by a ferroelectric film covered by a probe surface,
said electrode sheet including an electrode coupling forming an electrode path through at least one of said disk mounting components to a slider included in a head stack assembly, said slider including a resistive probe for contacting said probe surface to access a ferroelectric cell at a probe site on said probe surface by an electrical interaction between said resistive probe at said probe site and said electrode path; and
a voice coil motor mounted to said disk base and including said head stack assembly.

2. The ferroelectric disk drive of claim 1, wherein said disk mounting component may include at least one of a disk mount, a disk clamp, and at least one disk spacer.

3. The ferroelectric disk drive of claim 1, wherein access of said ferroelectric cell at said probe site on said probe surface by said electrical interaction of said resistive probe at said probe site and said electrode path, further comprises:
applying a first voltage between said resistive probe at said probe site and said electrode path to create an electric field retaining a first electric field direction as a retained electric field;
applying a second voltage between said resistive probe at said probe site and said electrode path to create said electric field retaining a second electric field direction essentially opposite said first electric field direction as said retained electric field; and
applying a third voltage between said resistive probe at said probe site and said electrode path to sense a current between said probe site and said electrode path to sense said retained electric field.

4. The ferroelectric disk drive of claim 1, wherein said disk surface includes at least two of said ferroelectric cells organized as a track and sharing said electrode sheet.

5. The ferroelectric disk drive of claim 4, wherein said track includes at least two sectors, each of said sectors including at least two of said ferroelectric cells sharing said electrode sheet.

6. The ferroelectric disk drive of claim 5, wherein each of said ferroelectric cells included in said sector share said electrode sheet.

7. The ferroelectric disk drive of claim 5, wherein said electrode sheet shared in a first of said sectors is not electrically coupled to said electrode sheet shared in a second of said sectors.

8. The ferroelectric disk drive of claim 4, wherein each of said ferroelectric cells organized as said track share said electrode sheet.

9. The ferroelectric disk drive of claim 1, wherein said probe surface includes a layer of lubricant over a layer of diamond like carbon over said ferroelectric film.

10. The ferroelectric disk drive of claim 9, wherein said lubricant comprises at least one perfluoropolyether compound.

11. A ferroelectric disk for use in a ferroelectric disk drive, comprising:
two disk surfaces and at least one electrode coupling formed on at least one of said disk surfaces;
an electrode sheet covered by a ferroelectric film covered by a probe surface included on at least one of said disk surfaces, said electrode sheet being electrically coupled to said electrode coupling; and
said probe surface comprising a layer of diamond like carbon over said ferroelectric film, and a layer of lubricant over said layer of diamond like carbon.

12. The ferroelectric disk of claim 11, wherein said lubricant comprises at least one perfluoropolyether compound.

13. The ferroelectric disk of claim 11, wherein said ferroelectric film includes a concentration comprising the elements: lead (Pb), zirconium (Z), titanium (Ti), and oxygen (O).

14. The ferroelectric disk of claim 13, wherein said ferroelectric film further includes a compound in said concentration consisting essentially of said group of said elements: said lead, said zirconium, said titanium, and said oxygen.

15. The ferroelectric disk of claim 14, wherein said compound is a Pb(Zr_{0.4}Ti_{0.6})O₃ compound.

16. The ferroelectric disk of claim 14, wherein said elements in said group of elements, forms at least ninety percent of the molecular weight of said compound.

17. The ferroelectric disk of claim 13, wherein said concentration is at least ninety nine percent of the weight of said ferroelectric film in a ferroelectric cell.

18. The ferroelectric disk of claim 11, wherein said first disk surface includes a succession of at least two tracks, each of said tracks organized into at least two sectors, each of said sectors including at least two of said ferroelectric cells, and each of said ferroelectric cells is included in at most one of said tracks.

19. A ferroelectric disk drive, comprising:
at least one of ferroelectric disk comprising two disk surfaces and at least one electrode coupling formed on at least one said disk surfaces, and at least one of said disk surfaces include an electrode sheet covered by a probe surface, said electrode sheet is electrically coupled to said electrode coupling.

20. The ferroelectric disk of claim 19, said electrode sheet covered by said probe surface, further comprises said electrode sheet covered by a ferroelectric film covered by said probe surface.

21. The ferroelectric disk drive of claim 20, wherein said probe surface comprises a layer of diamond like carbon over said ferroelectric film, and a layer of lubricant over said layer of diamond like carbon.

22. A method, comprising the step of accessing a track on a disk surface included in a ferroelectric disk comprising two of said disk surfaces and at least one electrode coupling formed on at least one said disk surfaces, whereby said electrode coupling is electrically coupled to an electrode sheet covered by a probe surface.

23. The method of claim 22, wherein the step accessing said track further comprises the steps of:
providing a voltage between a probe site on said probe surface and said electrode coupling to access a bit stored in a ferroelectric cell at said probe site, for each of said bits included in said track, further comprising the steps of:
providing said voltage between said probe site and said electrode coupling to write a bit value into said bit; and
providing a third voltage between said probe site and said electrode coupling to read said bit value from said bit.

24. The method of claim 23, wherein the step providing said voltage to write to said bit further comprises the steps:
providing a first voltage between said probe site and said electrode coupling to cause said ferroelectric cell to sustain a first electric field direction when said bit value is 0; and
providing a second voltage between said probe site and said electrode coupling to cause said ferroelectric cell to sustain a second electric field direction essentially opposite the first electric field direction, when said second voltage is opposite said first voltage in sign and said bit value is 1.

25. The method of claim 23, wherein the step providing said third voltage further comprises the step:
providing said third voltage between said probe site and said electrode coupling to read said bit value from said bit at a read-rate;
providing said voltage between said probe site and said electrode coupling to write said bit value into said bit at less than said read-rate.

26. A slider for use in a ferroelectric disk drive, comprising: an electrical coupling; a resistive probe; and an amplifier for sensing a current between said resistive probe and said electrical coupling.

27. The slider of claim 26, further comprising:
said electrical coupling is configured to electrically communicate with an electrode sheet covered by a probe surface on a disk surface;
said resistive probe is configured for contacting said probe surface to provide a voltage between a probe site on said probe surface and said electrical coupling to access a ferroelectric cell at said probe site; and
said amplifier is configured for sensing said current between said resistive probe and said electrical coupling to sense a retained electrical field of said ferroelectric cell to create an amplified read signal based upon said retained electrical field.

28. The slider of claim 26, further comprising: a write amplifier for receiving a write signal to generate a voltage at said resistive probe when writing to said ferroelectric cell.

29. The slider of claim 28, wherein said slider receives a write signal is an optical signal.

30. The slider of claim 26, further comprising an air bearing surface to create an air bearing for said slider lifting said air bearing surface off of a disk surface when a ferroelectric disk is rotated.

31. The slider of claim 26, further comprising a vertical micro-actuator for altering a contact pressure of said resistive probe on said probe surface.

32. The slider of claim 31, wherein said vertical micro-actuator employs at least one of a thermal-mechanical effect, a piezoelectric effect, and an electro-static effect.

33. A head gimbal assembly for a ferroelectric disk drive, comprising:
a slider comprising an electrical coupling and a resistive probe; and
a part of an electrode path to said electrical coupling.

34. The head gimbal assembly of claim 33, further comprising a micro-actuator assembly coupled to said slider to alter a contact pressure between said resistive probe and said probe surface, by employing at least one of a piezoelectric effect, an electrostatic effect and a thermal mechanical effect.

35. A head stack assembly for said ferroelectric disk drive, comprising:
a slider comprising an electrical coupling and a resistive probe; and
a part of an electrode path to said electrical coupling.

36. The ferroelectric disk drive, comprising:
at least one slider comprising an electrical coupling;
at least one ferroelectric disk comprising said electrode sheet covered by a probe surface; and
an electrode path formed between said electrical coupling and said electrode sheet;
at least one of said sliders further comprises a resistive probe for contacting said probe surface to access a ferroelectric cell.
